(19) United States
(12) Patent Application Publication
(10) Pub. No.: US 2021/0401071 A1
(43) Pub. Date: Dec. 30, 2021

(54) Female anti-wolf suit based on comprehensive positioning technology

(71) Applicant: Jiangnan University, Wuxi (CN)

(72) Inventor: Lei Shen, Wuxi (CN)

(73) Assignee: Jiangnan University

(21) Appl. No.: 17/472,687

(22) Filed: Sep. 12, 2021

(30) Foreign Application Priority Data
Dec. 25, 2020 (CN) 202011562638.6

(51) Int. Cl. A41D 1/00; A41D 1/14

(52) U.S. Cl. CPC A41D 1/002; A41D 1/14

(57) ABSTRACT

A female anti-wolf suit based on a comprehensive positioning technology, relating to a technical field of clothing, is provided, which effectively protects women from wolves. The female anti-wolf suit includes a suit main body, wherein: a control module is arranged at an abdominal position of the suit main body; the control module includes a GPS (Global Positioning System) chip, an NFC (Near Field Communication) module, and a battery supply, which are electrically connected to a CPU (Central Processing Unit) chip; the NFC module is for receiving a signal of a smartphone; and the GPS chip is for positioning a wearer.

### CROSS REFERENCE OF RELATED APPLICATION

The application claims priority under 35 U.S.C. 119(a-d) to CN 202011562638.6, filed Dec. 25, 2020.

### BACKGROUND OF THE PRESENT INVENTION

### Field of Invention

The present invention relates to a technical field of clothing, and more particularly to a female anti-wolf suit based on a comprehensive positioning technology.

### Description of Related Arts

In summer, because of high temperature, women are scantily clad, causing the increased probability of sexual assault incidents. At present, the most conventional method is to carry the anti-wolf device, such as the anti-wolf spray; when in danger, women can threaten the suspect with the anti-wolf device. However, there are still certain defects. When wearing a dress, women generally put the anti-wolf spray in the bag; if an emergency occurs, the anti-wolf spray often cannot be taken out immediately. Thus, it is difficult for the conventional anti-wolf technology to be sufficient.

### SUMMARY OF THE PRESENT INVENTION

Aiming at the problem that the conventional anti-wolf technology cannot effectively protect women, the present invention provides a female anti-wolf suit based on a comprehensive positioning technology, so as to effectively protect women from wolves.

Technical solutions of the present invention are described as follows.

A female anti-wolf suit based on a comprehensive positioning technology comprises a suit main body, wherein: a control module is arranged at an abdominal position of the suit main body; the control module comprises a GPS (Global Positioning System) chip, an NFC (Near Field Communication) module, and a battery supply, which are electrically connected to a CPU (Central Processing Unit) chip; the NFC module is for receiving a signal of a smartphone; and the GPS chip is for positioning a wearer.

Preferably, the suit main body is a one-piece dress, and safety pants are arranged on an internal side of the one-piece dress.

Preferably, detachable sleeves are arranged at a shoulder position of the one-piece dress; each of the detachable sleeves is connected to the one-piece dress through a button or Velcro®.

Preferably, the one-piece dress is integrated; an upper part of the one-piece dress has one layer, and an additional internal layer is arranged at a lower part of the one-piece dress, below a waist; the internal layer is the safety pants; an interlining is arranged at the abdominal position of the one-piece dress; the control module is arranged inside the interlining and wrapped by the interlining, and a position of the control module is fixed.

Preferably, a protection layer is arranged on a surface of the suit main body; the protection layer comprises a waterproof film, a flame-retardant layer, a cotton velvet layer, and a reinforcing rib wound by synthetic fiber filaments and cotton fiber filaments.

Preferably, the suit main body is made of polyurethane fibers.

Preferably, an internal layer of the suit main body comprises a one-piece upper part, a three-piece middle part and a one-piece lower part, which are all knitted by a cylinder with yarn overs; the middle part is at a waist of the suit main body; a knitting cycle is knitting 10 stitches for one wale and repeating for consecutive 10 wales, with knit stitches and yarn overs; and a pattern formed by knitting is continuous in all direction.

Preferably, a decorative button is arranged above the abdominal position of the one-piece dress; and the control module is integrated inside the decorative button.

Preferably, a type of the CPU chip is T7200 CPU 2.0/4M/667, a type of the GPS chip is E108-GN01, and a type of the NFC module is PN532 NFC RFID V3.

With the present invention, when meeting the wolf, women only need to move the mobile phone to the abdominal position; through the NFC technology, the message is sent to the contact instantly; meanwhile, through the GPS technology, the current position of the victim is tracked in real-time; even if the victim does not carry the mobile phone, the real-time position information can still be provided to the contact; through the application in the mobile phone of the contact, the position of the specific device is tracked and uploaded to the alarm platform immediately. The present invention has double alarm and protection effects, which effectively protects women form wolves.

### BRIEF DESCRIPTION OF THE DRAWINGS

FIG. 1 is a sketch view of a one-piece dress according to a preferred embodiment of the present invention;

FIG. 2 is a sketch view of a one-piece dress with sleeves according to the preferred embodiment of the present invention;

FIG. 3 is a structural sketch view of a button according to the preferred embodiment of the present invention;

FIG. 4 is a sketch view of a pattern design according to the preferred embodiment of the present invention;

FIG. 5 is a sketch view of a protection layer according to the preferred embodiment of the present invention; and

FIG. 6 is a sketch view of an internal layer according to the preferred embodiment of the present invention.

### DETAILED DESCRIPTION OF THE PREFERRED EMBODIMENT

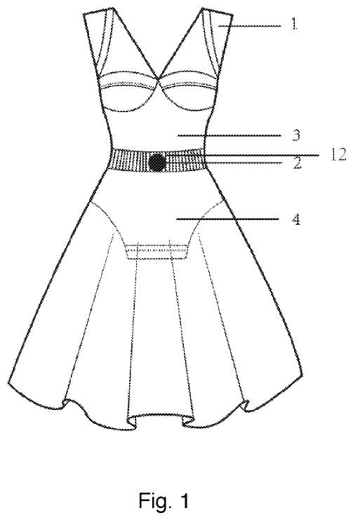

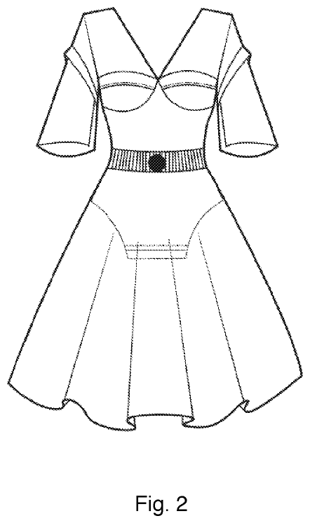

Referring to FIGS. 1-6, a female anti-wolf suit based on a comprehensive positioning technology comprises a suit main body 3, wherein: a control module 2 is arranged at an abdominal position of the suit main body 3; the control module 2 comprises a GPS (Global Positioning System) chip, an NFC (Near Field Communication) module, and a battery supply, which are electrically connected to a CPU (Central Processing Unit) chip 13; the NFC module is for receiving a signal of a smartphone; and the GPS chip is for positioning a wearer. When a victim is to be assaulted by a suspect, the victim can move the mobile phone to the abdominal position, which hardly alerts the suspect; through an NFC technology, connection is established and information is transmitted; through an application, according to set information of a contact, the mobile phone sends detailed address information of the victim to the contact by a text message. With the present invention, there is no need for the victim to conduct a complex operation for calling the police, and a problem that the suspect might be irritated by the action of calling the police and causes personal injury is avoided.

A type of the CPU chip 13 is T7200 CPU 2.0/4M/667, a type of the GPS chip is E108-GN01, and a type of the NFC module is PN532 NFC RFID V3.

In order to improve the product reliability, the control module 2 is integrated inside an internal button part of a button; a connection column, penetrating through the suit, is arranged on the internal button part of the button, and an external button part is connected with the connection column in threaded connection, so that the control module is fixed. Moreover, the button is detachable; when the suit needs to be washed, the button can be detached.

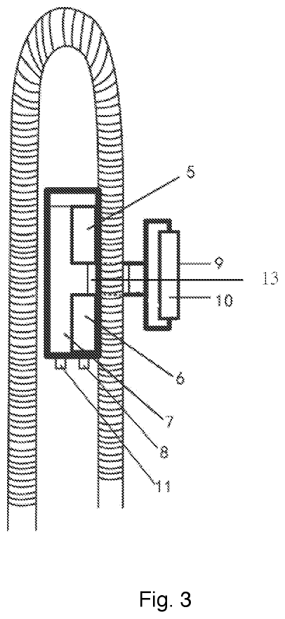

Referring to FIG. 3, the internal button part integrated with the NFC module and the GPS chip comprises the GPS chip 5, the NFC module 6, the battery supply 7 and a switch 8; as shown in FIG. 3, a screw button 9, like a peg-shaped brooch, can be fixed by screwing and detached; a micro pressure-charging device 10 is arranged on a surface of the screw button 9; through pressing the micro pressure-charging device, the kinetic energy is converted into the electric energy, so as to cope with an emergency condition of no electricity; through the connection column, the generated electricity is transmitted to the battery, and the battery is charged; alternatively, the battery can be charged through a USB (Universal Serial Bus); the switch is arranged below the control module; through rotating a knob of the switch, operation of the control module is controlled. In FIG. 3, a charging port 11 is shown.

With a one-piece dress as an example, the present invention is described in detail as follows.

The suit main body 3 is a one-piece dress; safety pants 4 are arranged on an internal side of the one-piece dress, for increasing the psychological security of women; detachable sleeves are arranged at a shoulder position 1 of the one-piece dress 3; each of the detachable sleeves is connected to the one-piece dress through a button or Velcro®, so as to cope with a temperature change; if a temperature difference between day and night is large, the sleeves can be detached in the day and attached at night.

An interlining is arranged at the abdominal position of the one-piece dress; the control module is arranged inside the interlining and wrapped by the interlining, and a position of the control module is fixed.

Referring to FIG. 6, a protection layer 12 is arranged on a surface of the suit main body; the protection layer 12 comprises a waterproof film 18, a flame-retardant layer 19, a cotton velvet layer 20, and a reinforcing rib 21, wherein: synthetic fiber filaments and cotton fiber filaments are wound on the reinforcing rib, providing waterproof and flame-retardant effects. The protection layer is firm and has the strong safety performance. Under the condition that clothes easily become wet, such as on a rainy day, the protection layer can ensure the normal operation of the GPS chip and the NFC module.

The suit main body is preferably made of polyurethane fibers with good elasticity, smoothness and excellent glossiness, so that it is not easily grasped by the suspect and the feasibility of the anti-wolf suit is effectively increased.

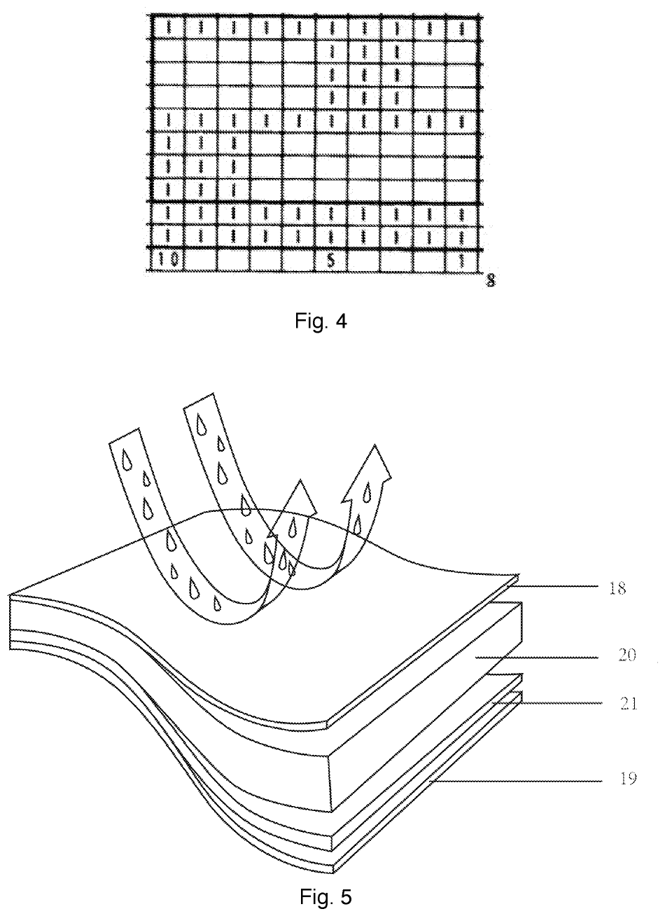

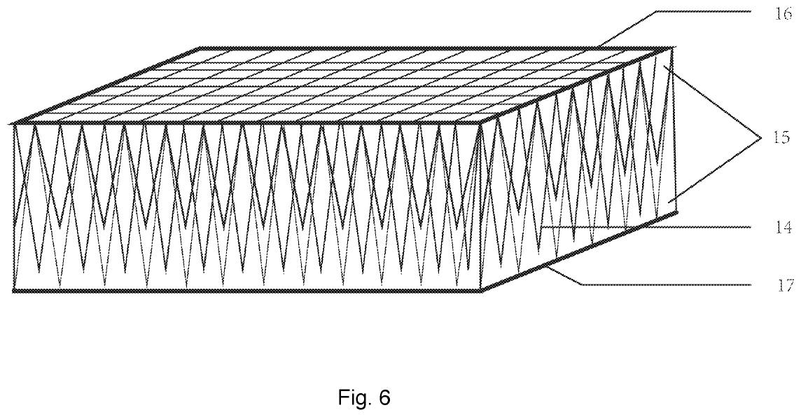

Referring to FIG. 5, an internal layer of the suit main body comprises a one-piece upper part 16, a three-piece middle part 15 and a one-piece lower part 17, which are all knitted by a cylinder with yarn overs 14; the middle part is at a waist of the suit main body; a knitting cycle is knitting 10 stitches for one wale and repeating for consecutive 10 wales, with knit stitches and yarn overs; and a pattern formed by knitting is continuous in all direction with double “H”. For the first and second wales, all stitches are knit stitches; for the third wale, the first to seventh stitches are yarn overs, and the eighth to tenth stitches are knit stitches; for the fourth wale, the first to seventh stitches are yarn overs, and the eighth to tenth stitches are knit stitches; for the fifth wale, the first to seventh stitches are yarn overs, and the eighth to tenth stitches are knit stitches; for the sixth wale, all stitches are knit stitches; for the seventh wale, the first, second and sixth to tenth stitches are yarn overs, and the third to fifth stitches are knit stitches; for the eighth wale, the first, second and sixth to tenth stitches are yarn overs, and the third to fifth stitches are knit stitches; for the ninth wale, the first, second and sixth to tenth stitches are yarn overs, and the third to fifth stitches are knit stitches; for the tenth wale, all stitches are knit stitches. Details are shown in FIG. 4.

With the present invention, when women wear the one-piece dress, once the power supply of the control module at the abdominal position is on, the anti-wolf suit starts to work; through the application, the remaining battery capacity of the anti-wolf suit can be checked at any time. Generally, after the control module is mounted into the anti-wolf suit, the power supply is always on; after the battery runs out, the control module no longer works and needs to be detached for replacing the power supply.

When the victim is to be assaulted by the suspect, the victim can move the mobile phone to the abdominal position, and the signal of the mobile phone is identified through the NFC technology; through the application in the mobile phone, according to the set information of the contact, the mobile phone sends the detailed address information of the victim to the contact by a text message; meanwhile, the text message has an alarm function, so that the contact can receive and look the text message at the earliest time; furthermore, once the contact opens the text message containing the address information, the real-time tracking and positioning function is executed, for finding the victim.

What is claimed is:

1. A female anti-wolf suit based on a comprehensive positioning technology, comprising a suit main body, wherein: a control module is arranged at an abdominal position of the suit main body; the control module comprises a GPS (Global Positioning System) chip, an NFC (Near Field Communication) module, and a battery supply, which are electrically connected to a CPU (Central Processing Unit) chip; the NFC module is for receiving a signal of a smartphone; and the GPS chip is for positioning a wearer.

2. The female anti-wolf suit, as recited in claim 1, wherein: the suit main body is a one-piece dress; and safety pants are arranged on an internal side of the one-piece dress.

3. The female anti-wolf suit, as recited in claim 2, wherein: detachable sleeves are arranged at a shoulder position of the one-piece dress; each of the detachable sleeves is connected to the one-piece dress through a button or Velcro®.

4. The female anti-wolf suit, as recited in claim 2, wherein: the one-piece dress is integrated; an upper part of the one-piece dress has one layer, and an additional internal layer is arranged at a lower part of the one-piece dress, below a waist; the internal layer is the safety pants; an interlining is arranged at the abdominal position of the one-piece dress; the control module is arranged inside the interlining and wrapped by the interlining, and a position of the control module is fixed.

5. The female anti-wolf suit, as recited in claim 1, wherein: a protection layer is arranged on a surface of the suit main body; the protection layer comprises a waterproof film, a flame-retardant layer, a cotton velvet layer, and a reinforcing rib wound by synthetic fiber filaments and cotton fiber filaments.

6. The female anti-wolf suit, as recited in claim 1, wherein: the suit main body is made of polyurethane fibers.

7. The female anti-wolf suit, as recited in claim 1, wherein: an internal layer of the suit main body comprises a one-piece upper part, a three-piece middle part and a one-piece lower part, which are all knitted by a cylinder with yarn overs; the middle part is at a waist of the suit main body; a knitting cycle is knitting 10 stitches for one wale and repeating for consecutive 10 wales, with knit stitches and yarn overs; and a pattern formed by knitting is continuous in all direction.

8. The female anti-wolf suit, as recited in claim 2, wherein: a decorative button is arranged above the abdominal position of the one-piece dress; and the control module is integrated inside the decorative button.

9. The female anti-wolf suit, as recited in claim 1, wherein: a type of the CPU chip is T7200 CPU 2.0/4M/667, a type of the GPS chip is E108-GN01, and a type of the NFC module is PN532 NFC RFID V3.
